(19) United States
(12) Patent Application Publication
(10) Pub. No.: US 2023/0408882 A1
(43) Pub. Date: Dec. 21, 2023

(54) OPTICAL ATTENUATOR

(71) Applicant: Telefonaktiebolaget LM Ericsson (publ), Stockholm (SE)

(72) Inventors: Fabio CAVALIERE, Vecchiano (Pisa) (IT); Paolo DEBENEDETTI, Albissola Marina (SV) (IT); Roberto MAGRI, Montignoso (MS) Massa Carrara (IT)

(21) Appl. No.: 18/266,971

(22) PCT Filed: Dec. 17, 2020
(86) PCT No.: PCT/EP2020/086837

§ 371 Date: Jun. 13, 2023

(51) Int. Cl. G02F 1/153; G02F 1/163; G02F 1/157

(52) U.S. Cl. CPC G02F 1/1533; G02F 1/163; G02F 1/157; G02F 2203/48

(57) ABSTRACT

Optical attenuators comprising electrochromic devices for telecommunications networks are provided. The optical attenuators are configured to reflect or refract an input optical signal using an electrochromic device, wherein the electrochromic device is configured to provide adjustable optical reflection or refraction levels.

### TECHNICAL FIELD

Embodiments described herein relate to an optical attenuator, in particular a telecommunications network optical attenuator comprising an electrochromic device.

### BACKGROUND

In order to allow data to be transmitted over optical fibres, telecommunications networks using optical signalling typically use multiplexing. Multiplexing of signals increases the capacity of fibres, and also allows bidirectional communication using a single fibre. A commonly used form of multiplexing for optical signalling is Wavelength Division Multiplexing (WDM), in which multiple signals are assigned different wavelengths to one another, allowing the signals to be carried on the same fibre.

Telecommunications networks using optical signalling frequently require optical signals to be attenuated, that is, for the intensity of signals to be reduced. Attenuation may be required for signals generated by the operator of a telecommunications network. An example of a situation in which attenuation may be required is in fronthaul networks with short links where an Avalanche Photodiode (APD) receiver may be overloaded by the power of a received signal (due to the shortness of the link, the signal power may not have been attenuated substantially by fibre between the transmitter and receiver), and it is not possible to directly control the launched power since the transmitter (which may be, for example, a Small Form factor Pluggable transceiver, SFP) is located in an external radio system or in an unmanned transponder.

A key implementation for attenuation arises where alien wavelengths are present in the network. Alien wavelengths (also referred to as alien lambdas) may be used to carry signals in a telecommunications network, where the signals are input into the network by a user other than the network operator; as such the network operator typically cannot directly control the properties of the alien wavelength. Alien wavelengths may be inserted into the network, for example, at unmanned sites where there is no direct control over the fibre access for the network operator.

Typically, attenuation is performed using a Variable Optical Attenuator (VOA) or equivalent component. Various different types of VOA are available; a schematic diagram of a typical

VOA unit is shown in FIG. 1. The VOA shown in FIG. 1 uses an opaque member to physically absorb a portion of a signal. An input signal enters the VOA at lens 101 (for example, from an optical fibre), and an output signal exits the VOA at lens 102 (for example, to an optical fibre). Between lens 101 and 102, the signal propagates through the VOA as indicated by the shaded area 103. A portion of the signal 103 is physically blocked from reaching lens 102 by shading member 104. As indicated by the double headed arrow in FIG. 1, the position of the shading member 104 can be adjusted to block more or less of the signal 103 from reaching the lens 102, thereby providing variable attenuation. The position of the shading member 104 may be adjusted using, for example, an electric motor. The electric motor may be remotely controlled, thereby providing a remotely adjustable optical attenuator. Prior to passing through the VOA unit for attenuation, the different wavelengths may be separated from one another using, for example, a Wavelength Selective Switching (WSS) array.

Existing VOA systems, such as the system shown in FIG. 1, typically require a continuous electrical power supply and a management interface to monitor the optical power of each alien lambda and eventually configure the required optical attenuation. This requirement for continuous power supply can be an issue for remote access sites, where power supply facilities could be limited or not available at all. Alternative passive solutions (not providing remote adjustability) such as fixed attenuators may not require a continuous power source, but may require in person site visits and monitoring of the alien lambdas with dedicated instruments, generating unsustainable operational costs. Also, fixed attenuators cannot be quickly adjusted if the alien lambda experiences, for whatever reason, an increase of optical power.

### SUMMARY

It is an object of the present disclosure to provide optical attenuators which at least partially address one or more of the challenges discussed above. In particular, it is an object of the present disclosure to provide optical attenuators for telecommunications networks that may require lower power than existing optical attenuators, and that may allow automatic attenuation configuration.

The present disclosure provides a telecommunications network optical attenuator comprising an electrochromic device. The optical attenuator is configured to reflect or refract an input optical signal using the electrochromic device, the electrochromic device being configured to provide adjustable optical attenuation levels. The telecommunications network optical attenuator may provide a power efficient means for attenuating optical signals, including alien lambdas, that may also apply the necessary attenuation automatically based on the levels of input signals into the optical attenuator.

In aspects of embodiments, the optical attenuator may comprise a voltage controller configured to apply a voltage to the electrochromic device. Providing a voltage controller in the optical attenuator is an efficient way to allow the attenuation level to be adjusted as required.

In aspects of embodiments, the optical attenuator may comprise a photovoltaic cell configured to generate electrical power from a portion of the input optical signal. The generated power may be used to charge a buffer battery, and may be used by the voltage controller. Generating power from incident optical signals allows the optical attenuator to operate in locations where alternative power sources are difficult to provide or not available.

In aspects of embodiments, the voltage applied to the electrochromic device by the voltage controller may be determined based on one or more of the level of electrical power generated by a photovoltaic cell and the monitoring results of a photodiode sensor. In this way, the optical attenuator may automatically determine the necessary level of attenuation without requiring external instructions.

### BRIEF DESCRIPTION OF DRAWINGS

The present disclosure is described, by way of example only, with reference to the following figures, in which:—

FIG. 1 is a schematic diagram of a known optical attenuator;

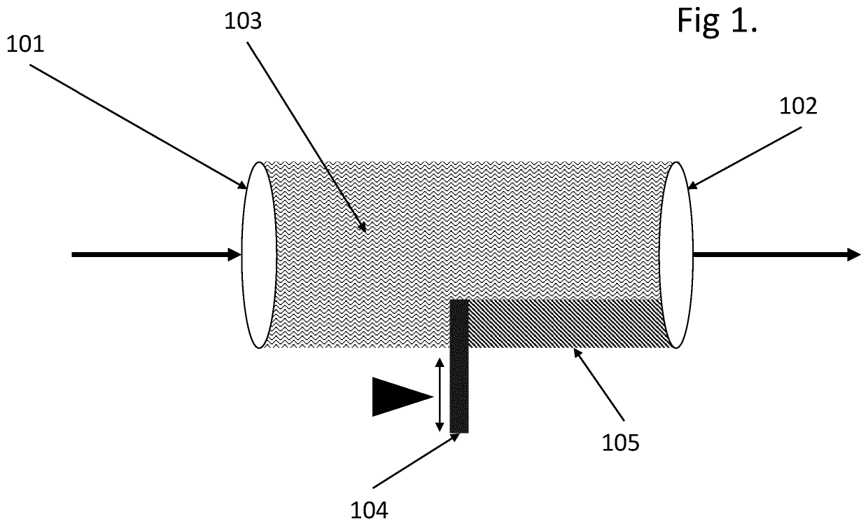

FIG. 2A is plot of transmission spectra for poly(3,3-dimethyl-2,2-bithiophenyl)-ITO film;

FIG. 2B is plot of transmission spectra for cholesteric liquid crystalline material;

FIG. 3 is a schematic diagram of a telecommunications network optical attenuator in accordance with aspects of embodiments;

FIG. 4 is a schematic diagram of a further telecommunications network optical attenuator in accordance with aspects of embodiments; and

FIG. 5 is a flowchart providing an overview of the operation of a telecommunications network optical attenuator in accordance with aspects of embodiments.

### DETAILED DESCRIPTION

For the purpose of explanation, details are set forth in the following description in order to provide a thorough understanding of the embodiments disclosed. It will be apparent, however, to those skilled in the art that the embodiments may be implemented without these specific details or with an equivalent arrangement.

Aspects of embodiments may rely upon the use of electrochromic devices. Electrochromism, as used by electrochromic devices, is the material property whereby a reflection or transmission coefficient (i.e. the ratio between reflected or transmitted light power and incident light power) of a material alters when a voltage is applied, with the degree of alteration being proportional to the magnitude and polarity of the voltage applied. An electrochromic device can be configured to reflect or attenuate ultraviolet, visible or near infrared light (typically telecommunications networks rely on near infrared light) on demand. When the reflection or transmission coefficient of an electrochromic material has been altered by the application of a voltage, the electrochromic material will not immediately revert to an unaltered state upon the removal of the voltage. Instead, the applied change is semi-persistent, and the material will revert to an unaltered state gradually over time (the time taken to revert is dependent upon the specific properties of the particular electrochromic material). At any time a voltage may be applied to reconfigure the device, making electrochromic materials an appealing technology for energy efficient optical attenuators.

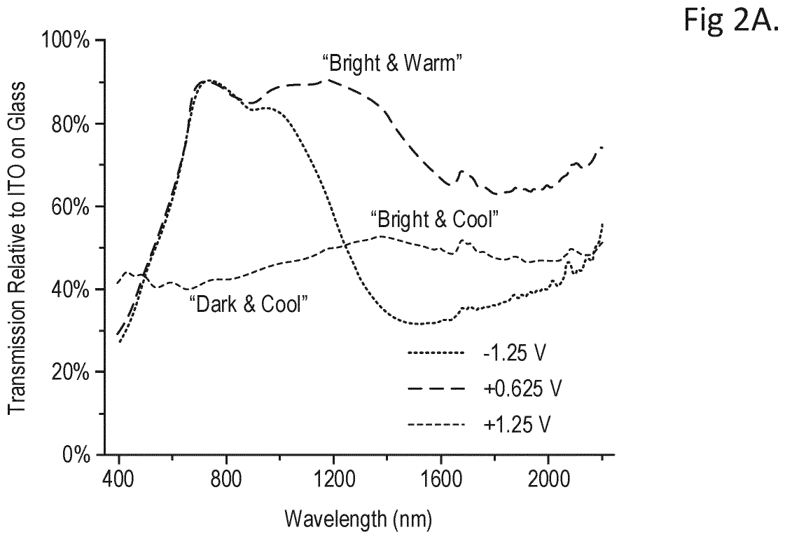

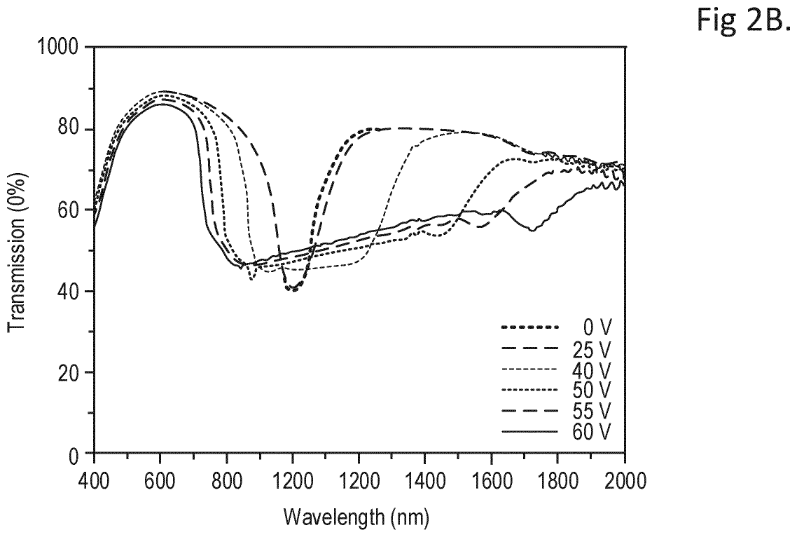

A discussion of the use of electrochromic materials in the context of infrared regulating windows can be found in “Infrared Regulating Smart Window Based on Organic Materials” by Khandelwal, H. et al, Advanced Energy Materials, 2 Mar. 2017, available at https://online library.wiley.com/doi/10.1002/aenm.201602209 as of 13 Nov. 2020. FIG. 2A and FIG. 2B are graphs that illustrate various properties of electrochromic materials.

FIG. 2A shows relative transmission spectra for a poly(3,3-dimethyl-2,2-bithiophenyl)-ITO (indium tin oxide) film, an example of an electrochromic material, when subjected to voltages of −1.25 V (labelled “Bright & Cool”), +0.625 V (labelled “Bright & Warm”) and +1.25 V (labelled “Dark & Cool”). The spectra labelled “Cool” indicate films that block more infrared radiation than those labelled “Warm”, and the spectra labelled “Dark” indicate films that block more visible radiation than those labelled “Bright”. When the relative transmissions at a typical infrared radiation wavelength of 1550 nm are considered, it is clear that applying a varying voltage to a poly(3,3-dimethyl-2,2-bithiophenyl)-ITO film can provide a broad transmission range. In particular, changing the voltage from −1.25V to 0.625V, causes the transmission coefficient at 1550 nm to change from 35% to 70% (i.e. −4.5 to −1.5 dB).

FIG. 2B shows relative transmission spectra for a Cholesteric (or ‘Chiral nematic’) liquid crystalline (Ch-LC) material (a further electrochromic material) when subjected to voltages of 0V, 25V, 40V, 50V, 55 V and 60 V. Again, it is clear that a variation in applied voltage can provide a significant range of transmission coefficients. In particular, changing the voltage from 0 V to 25V causes the transmission coefficient at 1550 nm to change from 55% to 80% (i.e. −2.6 to −0.1 dB). Different electrochromic materials provide different transmission spectra; the choice of which electrochromic material may be used in a particular system is dependent upon the characteristics of the system, including the range of voltages that can be applied to the material and the wavelength range of the light used by the system. Aspects of embodiments may use either of the electrochromic materials for which spectra are shown in FIG. 2, or may use further electrochromic materials as will be familiar to those skilled in the art. By selecting an electrochromic device having a desired response at the wavelength range of the light used by the system, attenuation coefficient ranges of 10% to 90% may be provided.

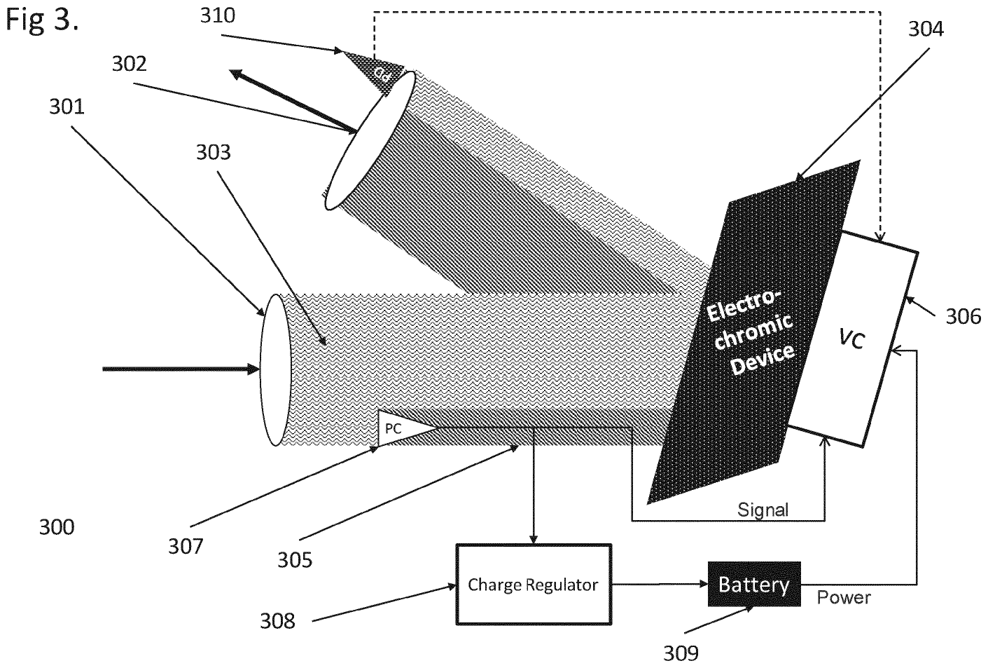

FIG. 3 is a schematic diagram of a telecommunications network optical attenuator 300 comprising an electrochromic device 304 in accordance with an aspect of an embodiment. Aspects of embodiments may comprise further components in addition to or alternatively to those shown in FIG. 3, for example, control circuitry to oversee the operation of the optical attenuator. In some aspects, the telecommunications network optical attenuator 300 is an attenuator device configured to attenuate (i.e. remove) unwanted wavelengths (e.g. alien lambdas). In some examples, the telecommunications network optical attenuator 300 is in a node of a radio access network, e.g. a fronthaul network. In some aspects, the attenuator 300 is in a node configured to receive an optical signal, e.g. from a transmitter of a different network or operator, for example in an external radio system or in an unmanned transponder. In other examples, the attenuator 300 is integrated into a network device, e.g. an add-drop multiplexer. In some aspects, the telecommunications network optical attenuator 300 is configured to control a power level at an output optical port, e.g. at an add port, pass through port or drop port. For example, the power level is controlled to be at a target power level, e.g. according to a pre-determined value and/or the same value as other wavelengths of a WDM system.

In the aspect of an embodiment shown in FIG. 3, an input optical signal enters the optical attenuator 300 via lens 301. Although typically an optical fibre conveys the optical signal to the optical attenuator 300, the input optical signal may arrive at the optical attenuator 300 via any suitable means. Similarly, in the aspect of an embodiment shown in FIG. 3, the output optical signal exits the optical attenuator via lens 302 (where the output optical signal may enter a further component, such as an optical fibre, switching unit, transceiver, and so on). The input optical signal may use a range of different wavelengths, frequencies, etc.; the optical attenuator may be configured to provide a range of attenuation in the wavelength, frequency range used by the input optical signal. The attenuation range may be determined at least in part by the selection of electrochromic material used in the electrochromic device. As an example, the input optical signal may use a wavelength of 1550 nm.

Inside the optical attenuator 300, the optical signal 303 propagates towards the electrochromic device 304. In the aspect of an embodiment shown in FIG. 3, a portion of the optical signal 305 does not arrive at the electrochromic device 304 and is instead incident on a photovoltaic cell 307. In the aspect of an embodiment shown in FIG. 3, the photovoltaic cell 307 is configured to generate electrical power from the incident portion of the optical signal 305; a portion of the output from the photovoltaic cell 307 is therefore passed to a charge regulator 308 connected to a buffer battery 309. The charge regulator 308 acts to prevent potential overcharging of the buffer battery 309, which could potentially cause damage to the buffer battery 309. In some aspects, the charge regulator 308 may be omitted; in these aspects of embodiments a buffer battery that is resistant to overcharging damage may be used.

As indicated by the arrow in FIG. 3, the power output from the buffer battery 309 may be supplied to a voltage controller 306, which may be configured to apply a voltage to the electrochromic device 304 as discussed in greater detail below. The buffer battery may also be omitted in aspects of embodiments, with the power from the photovoltaic cell passing directly to the voltage controller 306. In the aspect of an embodiment shown in FIG. 3, a further portion of the output from the photovoltaic cell 307 is passed to the voltage controller 306 as an input signal; this input signal may be used by the voltage controller 306 to determine the power of the optical signal 303 and thus to determine the extent to which the electrochromic device 304 should be used to attenuate the optical signal 303. The voltage applied to the electrochromic device is therefore determined at least in part by the level of electric power generated by the photovoltaic cell. In aspects of embodiments where a photovoltaic cell is not used, the power for the voltage converter may come from any suitable power source, for example: a pre-charged (potentially replaceable) battery, a solar cell exposed to sunlight, a mains power connection, and so on. Where a battery not connected to a photovoltaic cell is used, the optical attenuator may be configured to allow this battery to be periodically recharged using USB charging, wireless charging, or any convenient charging means.

In aspects of embodiments, such as the aspect of an embodiment shown in FIG. 3, a percentage of the optical signal 303 incident on the electrochromic device 304 is reflected towards the output lens 302; as such the degree of attenuation provided by the attenuator is determined by the reflectivity of the electrochromic device 304. In alternative aspects of embodiments, the telecommunications network optical attenuator may be configured such that a percentage of the optical signal incident on the electrochromic device is refracted towards the output lens; as such the degree of attenuation provided by the attenuator is determined by the refractivity of the electrochromic device.

In the aspect of an embodiment shown in FIG. 3, the voltage applied to the electrochromic device by the voltage controller is determined at least in part by the electrical power generated by the photovoltaic cell, as discussed above. In some aspects of embodiments (such as the aspect of an embodiment shown in FIG. 3), a further monitoring system that provides information to the voltage controller utilises a photodiode sensor 310. The photodiode sensor monitors the output optical signal from the electrochromic device, either immediately prior to the output optical signal exiting the optical attenuator or shortly after the output optical signal exits the optical attenuator. The measurements of the output optical signal taken by the photodiode sensor 310 are then fed back to the voltage controller, and used when determining the voltage to be applied to the electrochromic device. Where plural means for providing measurement information to the voltage controller are present (for example, the photocell and photodiode sensor as shown in FIG. 3), the voltage controller may utilise the measurements from all of the means, or from a subsection of the means, to determine when to apply a voltage and what voltage to apply to the electrochromic device. As the voltage controller determines the degree of attenuation required based on measurements at the optical attenuator, the optical attenuator does not require constant control from further components outside the optical attenuator (for example, external control from a network operator). Instead the optical attenuator provides an auto-levelling functionality. The voltage controller determines the degree of attenuation provided by the electrochromic device by adjusting the reflectivity of the electrochromic device; this may include adjusting a digital signal provided by the voltage controller to the electrochromic device to increase or reduce the respective reflective and non-reflective areas of the surface of the electrochromic device upon which the optical signal is incident. As discussed above, in alternative aspects of embodiments the refractivity of the electrochromic device may determine the degree of attenuation, and may be adjusted by a voltage controller.

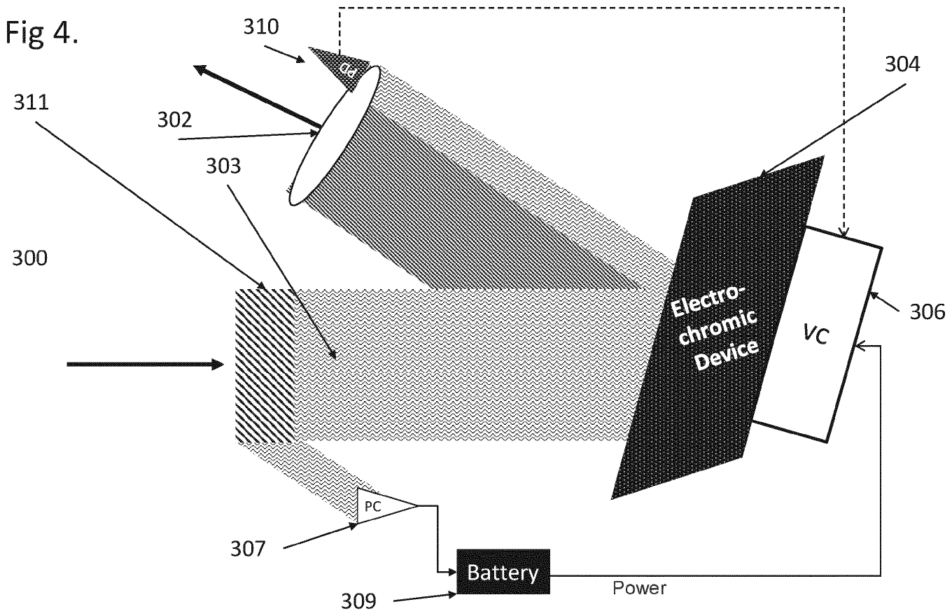

FIG. 4 is a schematic diagram of a telecommunications network optical attenuator 300 comprising an electrochromic device 304 in accordance with a further aspect of an embodiment. The optical attenuator 300 shown in FIG. 4 is similar in some respects to the optical attenuator 300 shown in FIG. 3; some of the differences between the two aspects of embodiments are discussed in more detail below.

In the optical attenuator shown in FIG. 4, the input optical signal enters the optical attenuator through a band split filter 311. The band split filter may be used to separate the portion of the input optical signal containing information from a further portion of the input optical signal, carried on a dedicated wavelength, which is used exclusively to provide power. The optical signal used to provide power may be provided on a dedicated optical fibre, or may be provided on the same optical fibre as is used to carry the input optical signal containing information.

This technique may be referred to as Power over Fibre (PoF), and may obviate the need to provide additional electrical power sources to comparatively low powered equipment (such as the telecommunications network optical attenuator 300). The optical signal used to provide power may be generated by any suitable source; lasers are typically well suited to this role.

The System Energy Efficiency (SEE) of PoF systems is defined as the product of the transmission loss and the optical-to-electrical conversion efficiency of the photovoltaic converter (in the aspect of an embodiment shown in FIG. 4, the photovoltaic converter is the photocell 307). “Multicore Fiber Scenarios Supporting Power Over Fiber in Radio Over Fiber 20 Systems” by Vazquez, C. et al, IEEE Access, 30 Oct. 2019, available at https://ieeexplore.ieee.org/document/8887435 as of 23 Nov. 2020, explains hownSEE of about 20% and 15% may be achieved using standard single mode fiber (SMF) and a 1550 nm laser. Accordingly, to provide 100 mW of power at a distance of 5 km, a laser power of 0.5W is needed.

As an approximate figure, telecommunications network optical attenuators in accordance with aspects of embodiments may require average power levels per day of approximately 0.3 μW cm⁻² day⁻¹, where the area (in cm) refers to the dimensions of the face of the electrochromic device upon which the input optical signal is incident. In addition to the electrochromic material used and the dimensions of the electrochromic device, the power requirements of network optical attenuators in accordance with aspects of embodiments is dependent upon the number of changes in the optical attenuation level of the electrochromic device required per day. The above approximate power level figure assumes 2 changes in attenuation level per day, therefore the average power level per attenuation level is approximately 0.15 μW cm⁻² day⁻¹. If a battery providing 800 mA at 3V (2.4 W) is provided, this battery could meet the power requirements of the above aspect of an embodiment for 40 months, assuming an electrochromic device incident face area of 0.1 cm².

Due to the low power requirements of telecommunications network optical attenuators in accordance with aspects of embodiments, PoF systems may be utilised to satisfy power requirements; this can be particularly convenient where the optical attenuators are located in remote or otherwise difficult to access locations (which may not be under the direct control of the telecommunications network operator) with no alternative power sources easily available. In some aspects of embodiments, the system may be configured such that an input power of 1 mW is received using the further portion of the input optical signal used in the PoF system at the optical attenuator from an optical source (such as a laser). A power of 0.8 mW may be retained after the band split filter. If a photocell having a minimum conversion ratio of 50% is used, this would result in the accumulation of 0.4 mW on the battery. A photodiode sensor can then be continuously powered to measure the output power of the filter when connected to the optical input (the photodiode sensor would not consume power when disconnected). The PoF system may be configured to provide the power at any suitable regularity, for example, the power could be provided constantly at a low level or via periodic higher level pulses.

In the aspect of an embodiment illustrated in FIG. 4, a band pass filter is used to separate the portion of the input optical signal containing information from the further portion of the input optical signal used in the PoF system. As such, the power levels recorded by the photocell 307 may not accurately represent the power levels of the portion of the input optical signal containing information. Therefore, the voltage controller 306 determines the voltage to apply to the electrochromic device 304 using the measurements from the photodiode sensor 310, without using measurements from the photocell 307.

As discussed above, in aspects of embodiments the voltage controller applies a voltage to the electrochromic device to control the degree of attenuation. When the voltage controller ceases applying a voltage to the electrochromic device the electrochromic device does not immediately return to a resting optical attenuation level (that is, the optical attenuation level the electrochromic device has when no voltage has been applied to the electrochromic device). Instead, the change in the reflection coefficient of the electrochromic device is semi-persistent, and the material will revert to a resting optical attenuation level gradually over time. In some aspects of embodiments, the electrochromic material may be selected such that the resting optical attenuation level of the electrochromic material is the same as the minimum optical attenuation level of the electrochromic device, that is, the maximum reflectivity of the electrochromic material.

The exact duration for the electrochromic device to return to a resting optical attenuation level is dependent upon various factors including the composition of the electrochromic device and the magnitude of the applied voltage, the duration may be selected depending upon specific system requirements. As an example, a duration of 15 minutes from the removal of a typical voltage level for an electrochromic device to return to a resting optical attenuation level may be provided. The return of the optical attenuator to a minimum attenuation level in the absence of applied voltages from the voltage controller ensures that, in the event of an issue with the control/power of the optical attenuator (for example, a battery powered optical attenuator where the battery reserve is exhausted), the optical attenuator will revert to a state in which it has a minimal effect on signals transiting the optical attenuator. Therefore the broader telecommunications network may continue to route signals via the optical attenuator until the issue with the optical attenuator can be resolved.

The gradual return of the electrochromic devices to a resting optical attenuation level also facilitates the low power requirements of the optical attenuators; the voltage controller may be configured to apply voltage pulses only when the input optical signal intensity and/or output optical signal intensity of the optical attenuator strays above a certain threshold or outside a certain range (as may be measured, for example, using a photodiode sensor monitoring the output signal from the optical attenuator). The threshold and/or range may be configured prior to installing the optical attenuator, may be communicated to the optical attenuator when installed, and so on. Through the use of voltage pulses only when required, the voltage controller may therefore use substantially less power than an alternative system requiring constant voltage application. As an example of this, a situation wherein a constant level of optical attenuation is required may be considered. In this example, if the voltage controller is configured to apply a 1 second voltage pulse to the electrochromic device and the gradual reversion of the electrochromic device to the resting optical attenuation level means that the pulse need not be applied for 1000 seconds, the voltage controller may then use approximately 1/1000 of the power that would be required to maintain a constant applied voltage over the same time period.

Optical attenuators in accordance with aspects of embodiments may be configured to constantly monitor the intensity of input optical signals and/or the intensity of output optical signals following passage through the optical attenuator; monitoring may be performed using some or all of the photocell and photodiode sensor monitoring options as discussed above and/or other monitoring systems. Alternatively, in order to further reduce the power consumption of the optical attenuator (which may be of particular interest when the optical attenuator is powered exclusively using a PoF system), the optical attenuator may be configured to monitor one or both of the input and output optical signals periodically. Where periodic monitoring is used for both the input and output optical signals, different monitoring periods may be used. The use of periodic monitoring means that monitoring systems can be powered down or enter a low power state between monitoring instances, thereby further reducing the power consumption of the optical attenuator.

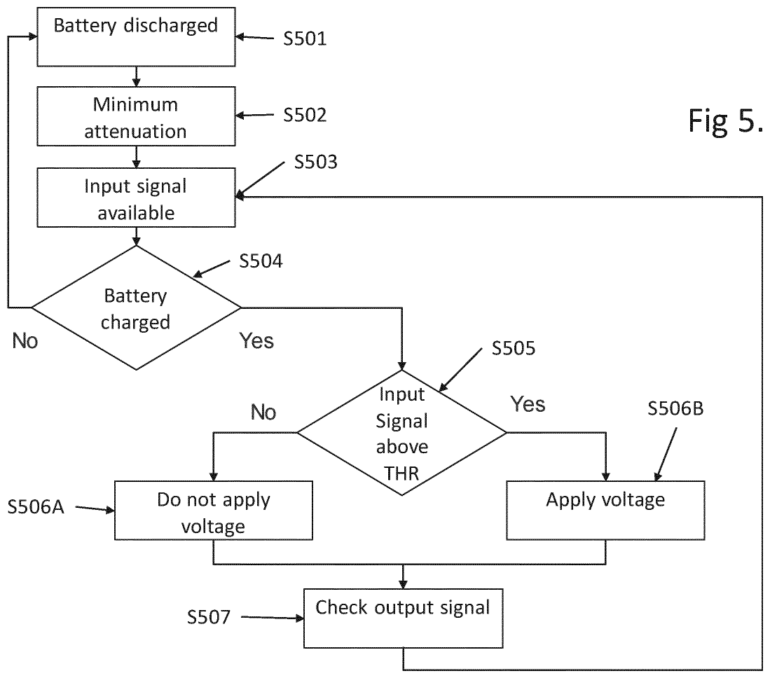

FIG. 5 is a flowchart providing an overview of the operation of an optical attenuator in accordance with an aspect of an embodiment. In the aspect of an embodiment to which FIG. 5 relates, a single threshold is used to control the attenuation coefficient of the optical attenuator. As explained above, further aspects of embodiments may use ranges to control the attenuation, and may not use both input signal monitoring and output signal monitoring (as is used in the FIG. 5 aspect of an embodiment). The aspect of an embodiment shown in FIG. 5 also utilises a portion of the input signal in a PoF system to power the optical attenuator; as also explained above, alternative power supply systems may be used.

In Step S501, the optical attenuator is in a state in which the battery (which is recharged using the PoF) is discharged. As shown in S502, the electrochromic device is in a state of minimum attenuation; in configurations such as those shown in FIG. 3 and FIG. 4, this equates to a state of maximum reflectivity. In other configurations, this may equate to a state of minimum refractivity. At S503, an input optical signal arrives at the optical attenuator and, via the PoF system, provides charge to the battery. When the battery has sufficient charge (S504—Yes), the optical attenuator determines whether the input signal intensity is above the threshold value (THR). Until the battery has acquired sufficient charge to allow the determination to be made, the electrochromic device remains in a state of minimum attenuation (S504—No).

When it is determined at S505 that the input signal intensity is higher than the THR (S505—Yes), a voltage is applied to the electrochromic device such that the attenuation of the electrochromic device is increased (5506B). Alternatively, when it is determined at S505 that the input signal intensity is not higher than the THR (S505—No), no voltage is applied to the electrochromic device (5506A). Following step 5506A or B, the output signal intensity is then checked (S507), before the process returns to step S503.

Optical attenuators in accordance with aspects of embodiments may support the controllable attenuation of input optical signals, such as alien lambdas, without requiring constant external control and with low power requirements. The optical attenuators may therefore be particularly suitable for use in locations where providing mains power or direct network operator control is challenging.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that incorporates an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/ or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure. For the avoidance of doubt, the scope of the disclosure is defined by the claims.

1. A telecommunications network optical attenuator comprising an electrochromic device,
wherein the optical attenuator is configured to reflect or refract an input optical signal using the electrochromic device, and
wherein the electrochromic device is configured to provide adjustable optical attenuation levels.

2. The optical attenuator of claim 1 comprising a voltage controller, wherein the voltage controller is configured to apply a voltage to the electrochromic device.

3. The optical attenuator of claim 2 comprising a photovoltaic cell, wherein the photovoltaic cell is configured to generate electrical power from a portion of the input optical signal.

4. The optical attenuator of claim 3, wherein the portion of the input optical signal used by the photovoltaic cell to generate electrical power is provided by a Power over Fibre, PoF, source.

5. The optical attenuator of claim 3 comprising a buffer battery, wherein the electrical power generated by the photovoltaic cell is used to charge the buffer battery.

6. The optical attenuator of claim 3, wherein the power generated by the photovoltaic cell is used by the voltage controller.

7. The optical attenuator of claim 3, wherein a voltage applied to the electrochromic device by the voltage controller is determined based on the level of electrical power generated by the photovoltaic cell.

8. The optical attenuator of claim 2, further comprising a photodiode sensor configured to monitor an output optical signal reflected by the electrochromic device.

9. The optical attenuator of claim 8, wherein a voltage applied to the electrochromic device by the voltage controller is determined by the monitoring results of the photodiode sensor.

10. The optical attenuator of claim 2, further comprising a battery.

11. The optical attenuator of claim 10, wherein the power from the battery is used by the voltage controller.

12. The optical attenuator of claim 10, wherein the battery is configured to be recharged periodically.

13. The optical attenuator of claim 1 wherein, if no voltage is applied to the electrochromic device for a time period, the electrochromic device is configured to provide a resting optical attenuation level.

14. The optical attenuator of claim 13, wherein the resting optical attenuation level is the same as a minimum optical attenuation level of the electrochromic device.

15. The optical attenuator of claim 1, wherein the input optical signal has a wavelength of approximately 1550 nanometers, nm.

16. The optical attenuator of claim 1, wherein the optical attenuation level range of the electrochromic device is between approximately 10% attenuation and approximately 90% attenuation.
